(19) United States
(12) Patent Application Publication
(10) Pub. No.: US 2018/0204475 A1
(43) Pub. Date: Jul. 19, 2018

(54) "Seeing eye" equivalent technology for adults-children, enabling supervision during task execution.

(71) Applicants: Margarita Ochoa Delgado, Las Rozas de Madrid (ES); Angela Isamel Lake Brunet, Las Rozas de Madrid (ES); Jose Eusebio Roza Pando, Ribadesella (ES)

(72) Inventors: Margarita Ochoa Delgado, Las Rozas de Madrid (ES); Angela Isamel Lake Brunet, Las Rozas de Madrid (ES); Jose Eusebio Roza Pando, Ribadesella (ES)

(21) Appl. No.: 15/405,551

(22) Filed: Jan. 13, 2017

(51) Int. Cl. G09B 5/06; H04N 7/18; G06F 3/16; G09B 5/02; G09B 5/04; G09B 19/00

(52) U.S. Cl. CPC G09B 5/065; H04N 7/185; G09B 19/00; G09B 5/02; G09B 5/04; G06F 3/16

(57) ABSTRACT

The invention herein, “Seeing Eye equivalent technology for adults—children, enabling supervision during task execution”, is a communication systems that allows remote and real time supervision so that one or several adults (supervisors) can oversee tasks carried out by a child (the supervised) or by a person with some handicap, guiding him/her via audio, and situating the supervisor's “de facto” in the place of the child or handicapped person. This implies that the supervisor hears and sees exactly the same thing that the supervised person hears and sees. This technology is intended for personal use; it does not store data and can be used at the request of the supervisor or the supervised person.

### TECHNOLOGICAL SECTOR

The invention herein pertains to the Information and Communications Technologies sector (I.C.T.).

The invention herein consists of an I.T. application that, by the means of special glasses, allows the supervisor (adult) to see and hear exactly what the supervised (child) does, with the objective of the supervisor (adult) being able to provide the supervised (child) with real time audio feedback, the finality of which is to supervise the child's activities or tasks. To practical effects, it's much like situating the adult in the exact place that the child is in.

### PRECEDENTS FOR THE INVENTION

We can currently find on the market:
Smart glasses: the wearer consumes information; said Information is displayed to the user superimposed on the normal view of reality.
Virtual glasses: the wearer consumes information, said information is displayed to the user, displaying and immersing him/her In an alternative virtual reality.
Subjective cameras: These cameras record information to create content, espionage etc.

In the invention subject of this application:
The wearer (who is supervised, due to difficulties because of young or old age, lessened capability, etc.) obtains help from an expert supervisor whom he/she knows, values and trusts. Said supervisor will guide him/her during task execution.
The wearer (supervised) does not consume the content: he/she generates it.
The wearer (supervised) can initiate the communication. However, it is the supervisor who controls said communication remotely.
The supervisor may also initiate the communication when he/she wishes.*

### EXPLANATION OF THE INVENTION

In order to reach the proposed objectives—for the supervisor to be situated in a practical sense in the same place as the supervised—the invention consists in a supervision communication technique (technological application) between the supervisor and the supervised via a wearable electronic device in the form of glasses (currently existent on the market). The proposed technique transmits an in first person view available to the wearer (supervised) to the recipient (supervisor), so that the recipient (supervisor) can put himself/herself in the place of the wearer (supervised) and help him/her in the execution of tasks.

The system is made up of the following subsystems (which are open to the addition of further accessories and improvements):

1. Glasses or Emitting Subsystem (emitter). Consists of:
1.1. A digital camera with automatic focus which allows macro focus at short range to facilitate reading of documents, as well as mid range focus.
1.2. A speaker that reproduces sound coming in from the supervisor/s as well as emitting acoustic signals alerting to important events (low battery level, connection initiated, etc.)
1.3. A call button, that alerts paired devices that the wearer wishes to initiate a connection.
1.4. Battery.
1.5. Wireless and/or USB charge system.
1.6. CPU, memory, others.
1.7. Integrated streaming server to code the outgoing signal with encoding and protocols similar to RSTP, appropriate for high quality so that said transmission is not affected by loss of data packages.
1.8. LEDs for notification in three colours:
   1.8.1. Connection enabled.
   1.8.2. Battery level low/medium/full
1.9. USB port and/or wireless charge for charging and configuration.
1.10. Wi-Fi communication card.
1.11. Receiver and decoder for the audio signal proceeding from the recepient and/or emitter.

2. Network Subsystem. Not physically forming part of the device, a local area network with broadband and connection to internet is required. No extra network configuration is required (opening of ports, DMZ demilitarized zones etc). In order to configure SSID network and the password to be used on the device, the USB port in the emitting device will be used.

3. Recipient Subsystem. Application to be executed on a general purpose electronic device with Internet access (typically a Smartphone, although possibly others such as Tablet P.C.'s, iPads, etc.), which connects to the remote (previously paired) device offering the video and audio signal to the device's user, whilst emitting an audio signal that can be heard by the wearer of the glasses. The application will include:
3.1. Pairing enablement between recipient and emitter. The pairing of devices will be carried out “in situ” via the capturing of a unique code by the Smartphone/others that does not permit access from other devices.
3.2. Multiple recipients will be supported so that, for example, both parents can supervise task execution. When an emitter presses the communication request button, the request will be received by all paired devices; said devices can respond individually or simultaneously.
3.3. Emitter Call alert (*the call can be initiated by the emitter or the recipient).

4. Server Subsystem. Communication will be established by all parties via an intermediary server that knows the location of all parties (IPs) and that can facilitate the communication without storing it.

### A BRIEF DESCRIPTION OF THE DRAWING

In order to enhance the description given and in order to help achieve a greater comprehension of the features of the invention, included herein is a set of drawings designed to be illustrative but in no way limiting, in which we find exposed:

FIG. 1.—A general diagram of ail components (hardware and the communication process between them.

FIG. 2. A general diagram of subsystem connectivity.

FIG. 3. An illustration of the practical application illustrating the emitter's view and the receipient's view.

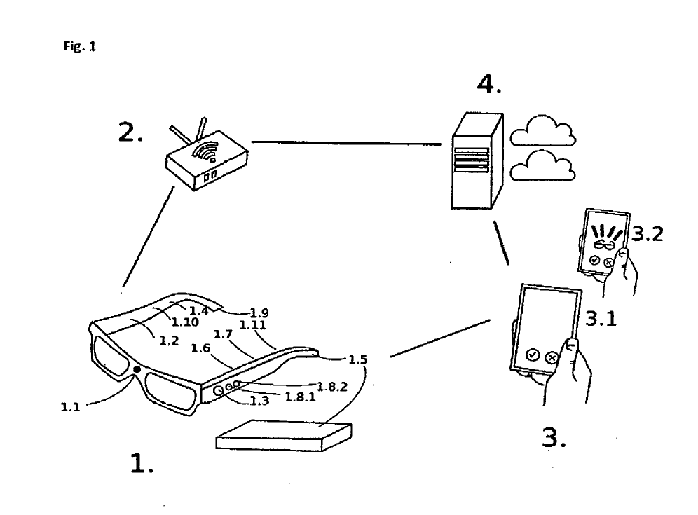

### PREFERED APPLICATION OF THE INVENTION

The communication technology has been designed and developed by the parties named in this application. Said technology can be installed on any device Android, iOS, iPhone, iPad, etc. Devices existent on the market (Smartglasses, others) support this technology, which is susceptible to adaptation and/or eventual improvement in accordance with the development of new hardware on the marketplace.

### INDUSTRIAL APPLICATION

From all that which has been previously exposed, the industrial application of the invention is evident.

1. An application that enables an adult (supervisor) remotely and in real time, to supervise children (the supervised) in the execution in their own home and/or a private setting where a private Wi-Fi connection is located, in the execution of tasks, be these homework or tasks of any other nature. It is characterised by:
a. Situating the adult (supervisor) “in practical terms” by the side of the child (supervised person), allowing him/her to see and hear what the child sees and to guide him/her via the audio feed.
b. The application can be supported by Smartglasses that currently exist on the market. This allows the child (supervised person) to have their hands free to directly follow the adult (supervisor's) instructions, so that the adult can observe in real time the comprehension and execution of his/her instructions; thus allowing the child to carry out homework that may include manual tasks (crafts), resolve mathematical problems, etc.

2. An application that, in line with previous claims, allows the supervisor to guide, assist or help the supervised (child) at home or in a private location with a private Wi-Fi connection, in the tasks of searching for objects, notes, pieces, etc. For example: “mum/dad, where are the scissors, the iodine? etc.)

3. An application that, in line with previous claims, allows the supervisor to guide, assist or help the supervised (child) at home or in a private location with a private Wi-Fi connection, during a moment that could pose a potential hazard. For example: “mum/dad, there's water coming out of the washing machine . . . . You look at it . . . . You call the technician”. Or, to the contrary, it may be the supervisor who initiates the call in order to make sure that the situation where the supervised (child) is located is safe and normal and no intervention is required.

4. An application that, in line with previous claims, allows the supervisor to guide, assist or help the supervisor (child) at home or in a private location with a private Wi-Fi connection, to assist in a moment that they may need to configure or reset a device such as a games console.

5. An application that, in line with previous claims, allows the supervisor to guide, assist or help the supervised (child) at home or in a private location with a private Wi-Fi connection that can serve the same purpose between adults-children as it can between adults-people suffering from some handicap, in the case of need. We can use, as an example, instructions on turning on a boiler, supervision during food preparation, etc. That is to say, anything that can require the supervisor to be able to visualize a task as it is carried out, and that at the time requires of an audio feedback and the supervised person to have free hands to carry out the instructions as they are received.

6. An application that, in line with previous claims, can serve this same purpose for any other nature of tasks that require expert supervision.
